(19) United States
(12) Patent Application Publication
(10) Pub. No.: US 2010/0266801 A1
(43) Pub. Date: Oct. 21, 2010

(54) LOW-EMISSIVITY WINDOW FILM AND PROCESS FOR PRODUCING SUCH A FILM

(75) Inventors: Peter Jahoda, Ridgeway, VA (US); Ricardo Romero Orozco, Downey, CA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Optimum Coating Technologies, S.A. de C.V.

(21) Appl. No.: 12/423,866

(22) Filed: Apr. 15, 2009

(51) Int. Cl. B32B 33/00; B32B 27/00; C08F 2/48

(52) U.S. Cl. 428/41.8; 428/412; 428/339; 428/220; 427/492

(57) ABSTRACT

A non-laminated low-emissivity window film includes a flexible polymeric substrate having a first surface and an opposed second surface. A metal-adhesion promoting layer is disposed on the first surface, a reflective metal layer is disposed on the metal adhesion-promoting layer, and a transparent polycarbonate coating is disposed on the metal layer. The window film can have an emissivity of about 0.27 to about 0.33 and a visible light transmission of at least about 17 percent.

### FIELD OF THE INVENTION

The invention relates to solar window films for controlling the influx of solar radiation through windows, and more particularly relates to an improved window film having low emissivity and excellent durability.

Solar control window films are known for reflecting incident solar radiation away from windows and associated structures. As used herein, the terms “solar control window film,” “solar window film,” “window film” and “film” are used interchangeably unless indicated otherwise by their context or usage. Solar window films typically include a thin metallized polymeric film which can be adhered to an interior surface of a glass window with a suitable adhesive material. Typically, a thin layer of reflective metal such as gold, silver, copper, aluminum, or the like is applied to one face of a polymeric substrate by vacuum or vapor deposition, for example. Obtaining good adhesion of the deposited metal to the polymeric substrate can be problematic. In order to protect the metal layer from scratching and from attack by cleaning agents and the like, a second polymeric film can be laminated over the metal layer using a suitable adhesive material.

Solar window films are typically characterized by several characteristics or parameters. For example, a solar window film is often characterized by the percentage of total incident solar radiation (including infrared, visible, and ultraviolet solar radiation) which is reflected by the film when the film is applied to a transparent glass window. This attribute is known as “solar reflectance.” Solar window films also are characterized by the percentage of total incident solar radiation that is absorbed (“solar absorptance”) and by the percentage of total incident solar radiation which passes through the glass and film (“solar transmittance”). The solar reflectance value, solar absorptance value, and solar transmittance value of a solar window film necessarily add to 100 percent (1.0). Solar window films are also characterized by the percentage of incident visible light which passes through the glass and film, which is known as “visible light transmittance.”

One problem with laminated solar window films is that the adhesive layers which bond the laminated layers together can increase the solar absorptance of the film, and thereby promote unwanted heating of the solar film. In an attempt to alleviate this problem, others have attempted to protect the metal layers of solar films with protective coatings rather than laminated protective films. Unfortunately, the protective coatings of known non-laminated solar films may not adequately adhere to the metal layers which they are intended to protect, and the coatings can be prone to scratching, hazing and/or separation from the metal layers to which they are applied when the films are repeatedly cleaned with common window cleaning equipment and cleaning agents. Accordingly, such films must be handled, installed and cleaned with extreme care.

Another characteristic of solar window films is how they respond to far-infrared radiation. Far-infrared radiation naturally radiates from a surface of a warmer object to a surface of a colder object. Accordingly, far-infrared radiation can naturally radiate from a warmer object to a colder exterior window, for example. In particular, when an interior space is heated, thermal energy can be lost when a colder exterior window absorbs far-infrared radiation from warmer interior objects rather than reflecting such energy back into the interior space. In addition, when an interior space is being cooled, unwanted gains in thermal energy can occur when an exterior window heats up due to absorption of far-infrared radiation from warmer exterior objects.

In order to alleviate this problem, low-emissivity solar window films have been developed. “Emissivity” refers to a surface's ability to absorb far-infrared radiation. Accordingly, the term “low-emissivity” is used to describe surfaces that are capable of reflecting rather than absorbing a substantial portion of incident far-infrared radiation. Though known low-emissivity window films can reduce thermal losses or gains which are attributable to unwanted absorption of far-infrared radiation, known low-emissivity window films are prone to the same problems described above for solar window films in general. More specifically, laminated low-emissivity window films include one or more adhesive layers which can cause unwanted absorption of thermal energy by the films. In addition, the protective coatings of known non-laminated low-emissivity window films are prone to scratching, hazing and/or separation from the metal layers to which they are applied when the films are repeatedly cleaned with common window cleaning equipment and cleaning agents, and must be handled, installed and cleaned with extreme care.

### SUMMARY

In one embodiment, a non-laminated low-emissivity window film according to the invention includes a flexible polymeric substrate having a first surface and an opposed second surface. A metal-adhesion promoting layer is disposed on the first surface, a reflective metal layer is disposed on the metal adhesion-promoting layer, and a transparent polycarbonate coating is disposed on the metal layer. The window film can have an emissivity of about 0.27 to about 0.33 and a visible light transmission of at least about 17 percent.

In another embodiment, the invention includes a method of producing a low-emissivity window film. The method includes providing a flexible polymeric substrate, and depositing a metal layer on one surface of the polymeric substrate to form a metallized surface. The method further includes applying a thin first coat of a UV-curable polycarbonate coating over the metallized surface, drying the first coat, and exposing the first coat to ultraviolet light until the first coat is partially cured. The method also includes applying a thin second coat of a UV-curable polycarbonate coating over the first coat, drying the second coat, and exposing the first coat and the second coat to ultraviolet light until both the first coat and the second coat are fully cured.

These and other aspects and features of the invention will be understood from a reading of the following detailed description together with the drawings.

### BRIEF DESCRIPTION OF THE DRAWINGS

FIG. 1 is a cross section of one embodiment of a film according to the invention.

FIG. 2 is a cross section of another embodiment of a film according to the invention.

FIG. 3 is a cross section of an additional embodiment of a film according to the invention.

FIG. 4 is a cross section of a further embodiment of a film according to the invention.

FIG. 5 is a cross section of another embodiment of a film according to the invention.

FIGS. 6A-6C show a sequence of steps for applying a protective coating to a film according to the invention.

### DETAILED DESCRIPTION

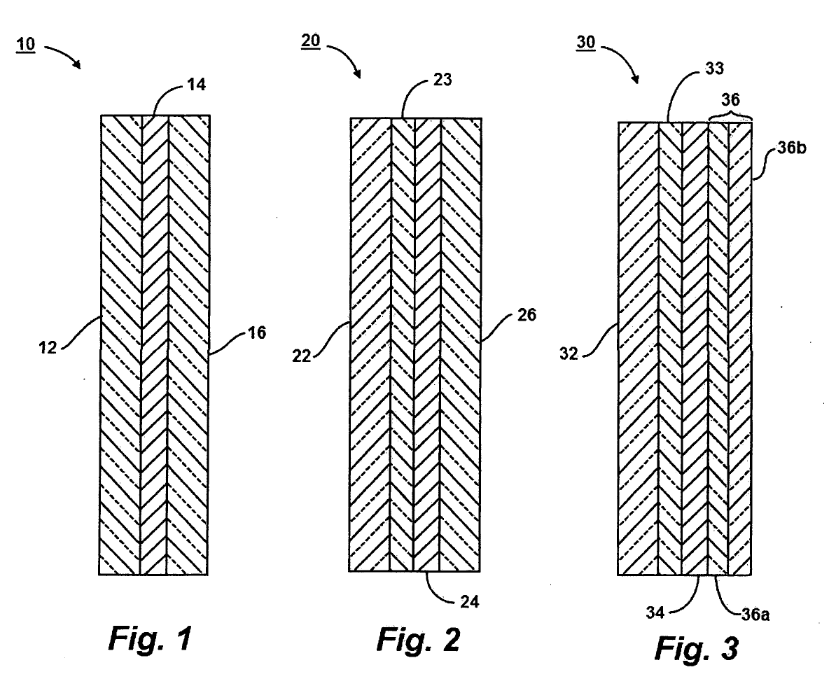

FIG. 1 shows a representative cross section of one embodiment of a non-laminated low-emissivity window film 10 according to the invention. In this embodiment, the film 10 includes a polymeric substrate 12, a reflective metal layer 14, and a protective coating 16. The polymeric substrate can be a polyester substrate, such as polyethylene terephthalate (PET), for example. Though the polymeric substrate 12 can have substantially any thickness, a preferred thickness is from about 0.5 mil to about 4.0 mils, and a more preferred thickness is from about 1 mil to about 2.0 mils. Preferably, the polymeric substrate 12 is highly transparent, and has less than about 1 percent haze. Optionally, the polymeric substrate 12 can be dyed or colored to provide the film 10 with a desired appearance and/or reduced transparency. The relative thicknesses of the various film layers shown in FIG. 1 and in FIGS. 2-6C are not necessarily drawn to scale, and do not necessarily indicate any preferred relative thicknesses of the various layers of the films described herein.

The reflective metal layer 14 includes a highly reflective metal or metal oxide. In a preferred embodiment, the reflective metal layer 14 is aluminum. Other metals which can be used for the reflective layer are gold, silver, chrome, titanium, nickel-chromium, and the like. The metal used for the reflective metal layer 14 can be selected in order to provide the film 10 with a desired color, for example. The metal layer 14 can be applied to one surface of the polymeric substrate 12 by resistive vapor deposition in a vacuum. Alternatively, the metal layer 14 can be applied by any other suitable process. The density of the metal layer 14 can be varied in order to produce a film 10 having a desired balance between overall visible light transmission and emissivity. Generally, the greater the density of the metal layer 14, the lower the visible light transmission and the lower the emissivity of the film 10. Preferably, the density of the metal layer 14 is selected such that the film 10 has an emissivity of about 0.27 to about 0.33, and a visible light transmission of about 17 percent to about 22 percent. Lower emissivities for the film 10 can also be achieved at lower levels of visible light transmission, and higher levels of visible light transmission can be achieved at higher levels of emissivity.

The protective coating or layer 16 is applied over the metal layer 14. Preferably, the protective coating 16 is extremely thin and substantially invisible to infrared radiation such that the coating will not adversely affect the low emissivity of the film 10. In other words, the protective coating 16 is preferably extremely thin and transparent such that infrared radiation passes through the protective coating 16 with little or no absorption by the coating 16. In one embodiment, the protective coating 16 is a hard and highly transparent UV-curable polycarbonate coating, and has an extremely thin thickness of about 1 micron to about 3 microns. Such a polycarbonate coating can include a mixture of pentaerythritol tetraacrylate, pentaerythritol triacrylate, an acrylic ester, a diluent, a photo initiator, and a surface modifier. The polycarbonate coating can also include a trifunctional acid ester to promote adhesion of the protective coating 16 to the metal layer 14. One such trifunctional acid ester is CD9053, which is available from Sartomer Company, Inc., of Exton, Pa. In one embodiment, a mixture is formed which includes about 75-85 percent pentaerythritol triacrylate, about 8-9 percent diluent, about 6-8 percent photo initiator, about 0.1-0.2 percent surface modifier, and about 3-5 percent trifunctional acid ester. This mixture can be combined with a solvent at a ratio of about 1 part mixture to about 4 parts solvent. A thin coat of the resulting solution can be applied to the surface of the metal layer 14 and dried to evaporate the solvent and leave behind the remainder as solids. The remaining solids can be cured by exposure to ultra violet light, resulting in a hard and scratch-resistant low-emissivity protective coating 16.

A polycarbonate protective coating 16 as described above is superior to the protective coatings of known low-emissivity window films due to its high transparency, invisibility to infrared radiation, hardness, and high resistance to hazing, scratching, other mechanical damage, and exposure to common window cleaning agents. In one embodiment, the protective coating 16 has a maximum haze increase of less than about 3 percent when tested according to ASIM D 1044. One process for forming a protective coating layer 16 on the metal layer 14 is described in detail below.

Another embodiment of a non-laminated low-emissivity window film 20 according to the invention is shown in FIG. 2. In this embodiment, an adhesion promoting layer 23 is disposed between a polymeric substrate 22 and a reflective metal layer 24. The adhesion promoting layer 23 can be applied to an interior surface of the polymeric substrate 22 before the metal layer 24 is deposited on the surface. Like the polymeric substrate 12 described above, the substrate 22 can be a polyester substrate, such as polyethylene terephthalate (PET), for example. Preferably, the combined polymeric substrate 22 and adhesion promoting layer 23 are highly transparent, and have less than about 1 percent haze. Optionally, the polymeric substrate 22 can be dyed or colored to provide the film 20 with a desired appearance and/or reduced transparency. Preferably, the combined thickness of the polymeric substrate 22 and adhesion promoting layer 23 is from about 0.5 mil to about 4 mils, a more preferred thickness is from about 1 mil to about 2 mils, and a most preferred thickness is about 1.5 mils.

The adhesion-promoting layer 23 facilitates the adhesion of the metal layer 24 to the coated substrate 22, and substantially reduces the possibility that the metal layer 24 might peel away or otherwise separate from the base substrate 22. In one embodiment, the adhesion-promoting layer 23 can be like the adhesion-promoting layers described in U.S. Pat. No. 6,114,021 to E.I. du Pont de Nemours and Company, for example, the disclosure of which is hereby incorporated by reference in its entirety. One example of a substrate 22 having an adhesion-promoting layer 23 which can be used to produce a film 20 according to the invention is Melinex® X6560, which is available from DuPont Teijin Films™, Hopewell, Va. Melinex® X6560 is a polyester film having excellent optical characteristics and a pretreatment 23 on one surface which promotes metal adhesion to the polyester film. As shown in FIG. 2, a protective coating 26 can be applied over the metal layer 26. The reflective metal layer 24 and the protective coating 26 can be substantially as described above for reflective metal layer 14 and protective coating 16, respectively. One process for applying the protective coating 26 over the metal layer 24 is described in detail below.

Another embodiment of a non-laminated low-emissivity window film 30 according to the invention is shown in FIG. 3. The film 30 can be substantially similar to the film 20 shown in FIG. 2 and described above, but can include a protective coating 36 comprising at least a two layers 36a, 36b. The film 30 includes a polymeric substrate 32, an adhesion promoting layer 33, and a reflective metal layer 34 covered by the protective coating layer 36. The polymeric substrate 32, adhesion promoting layer 33, and reflective metal layer 34 can be substantially similar to the polymeric substrates 12, 22, adhesion promoting layer 23, and reflective metal layers 14, 24 described above, respectively. Each of the protective coating layers 36a, 36b can be the same as or substantially similar to the highly transparent UV-curable polycarbonate coatings 16, 26 described above. The protective coating layers 36a, 36b can have a cured thickness of about 0.5 micron to about 1.5 microns, and a combined cured thickness of about 1 micron to about 3 microns, for example. One process for applying the protective coating 36 over the metal layer 34 is described in detail below.

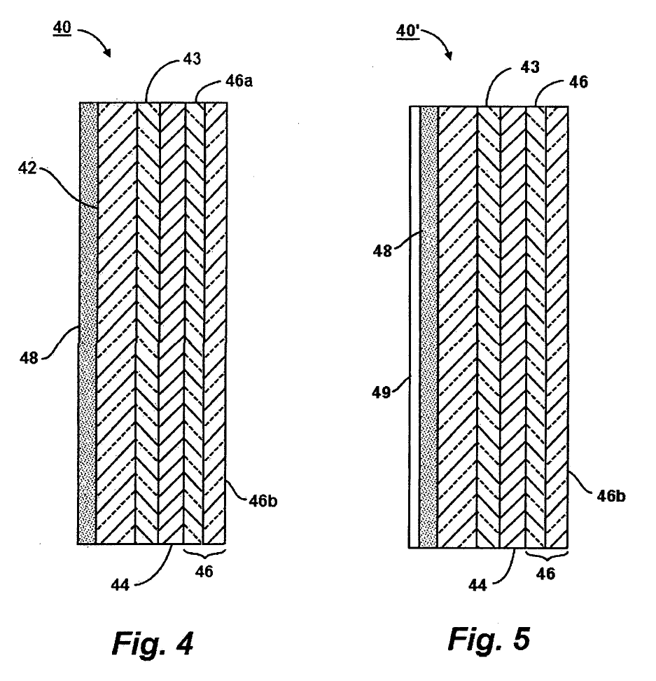

An additional embodiment of a film 40 according to the invention is shown in FIG. 4. The film 40 shown in FIG. 4 is substantially similar to the film 30 shown in FIG. 3 and described above, but also includes a mounting adhesive layer 48. The film 40 includes a polymeric substrate 42, an adhesion promoting layer 43, and a reflective metal layer 44 covered by the protective coating layer 46. The protective coating layer can include two or more sub-layers 46a, 46b. The mounting adhesive layer 48 can be provided on an exterior surface of the polymeric substrate 42. In one embodiment, the mounting adhesive layer 48 is a pressure sensitive adhesive material, such as product no. 1059 by National Starch and Chemical Company, for example. Alternatively, the mounting adhesive layer 48 can be a water-activated adhesive material, such as ADCOTE™ 89R3 by Rohm and Haas, for example. The mounting adhesive layer 48 facilitates attachment of the film 40 to an interior surface of a window. Preferably, the mounting adhesive layer 48 is as thin as possible and is substantially transparent to visible light such that the adhesive layer 48 does not substantially adversely affect visible light transmission through the film 40. As shown in FIG. 5, when the mounting adhesive layer 48 is a pressure sensitive adhesive, a removable release liner 49 can be provided over the adhesive layer 48. The release liner 49 can be selectively removed from the adhesive layer 48 before attaching the film 40 to an interior surface of a window. Though not shown in FIGS. 1-3, a mounting adhesive layer 48 like that shown in FIG. 4 or a mounting adhesive layer 48 and a release liner 49 like that shown in FIG. 5 can also be provided on the films 10, 20 and 30 described above. Optionally, the mounting adhesive 48 can be colored, and/or can include an ultraviolet absorber.

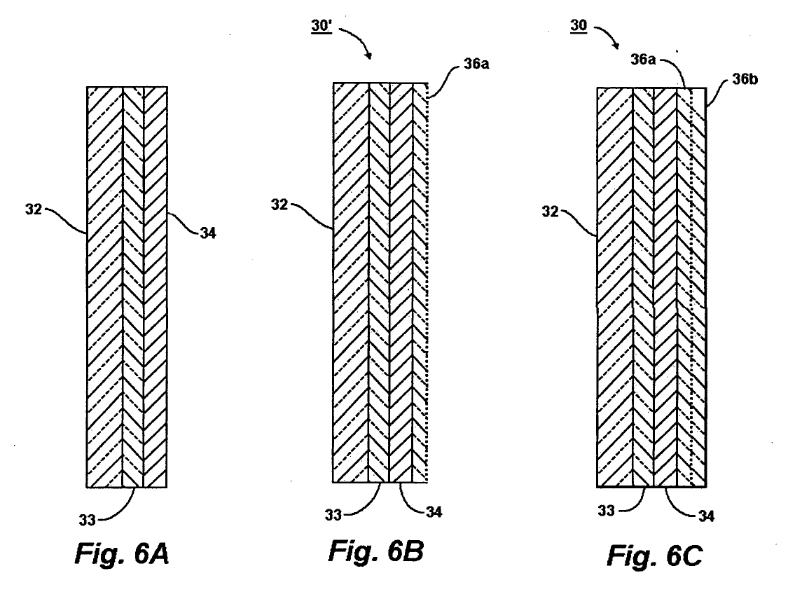

As discussed above, the polycarbonate protective coatings 16, 26, 36, 46 of the films 10, 20, 30 and 40 are superior to the protective coatings of known low-emissivity window films due to their high optical transparency, their greater hardness, their greater resistance to hazing, scratching, other mechanical damage, and their greater resistance to damage from exposure to common window cleaning agents. Unfortunately, applying an extremely thin and uniform protective polycarbonate coating to a metallized surface of a window film can be fraught with difficulties. First, when a thin coat of polycarbonate coating is applied to a metallized surface, the wet coating tends to lay on the wetted surface in a non-uniform manner such that thick areas and thin areas are formed. Once cured, such a non-uniformly applied polycarbonate coating may have unacceptably irregular optical qualities, and thinner areas of the coating may not adequately protect the underlying metal layer from damage. In order to solve these problems, the inventors of the present invention have developed a process for applying an extremely thin, highly transparent and substantially uniform polycarbonate coating to a metallized surface of a low-emissivity window film. One embodiment of such a process is illustrated in FIGS. 6A-6C.

As shown in FIG. 6A, a reflective metal layer 34 is disposed on an adhesion-promoting coating 33 which covers an interior surface of a polymeric substrate 32. The reflective metal layer 34, the adhesion promoting coating 33, and the polymeric substrate 32 can be substantially as described above regarding the film 30 shown in FIG. 3, for example. In one embodiment, the coated substrate (including substrate 32 and adhesion-promoting layer 33) are Melinex® X6560 by DuPont Teijin Films™, Hopewell, Va. In one embodiment, the combined thickness of the substrate 32 and adhesion-promoting coating 33 is from about 0.5 mil to about 4 mils. A more preferred combined thickness is from about 1 mil to about 2 mils, and a most preferred thickness is about 1.5 mils. Films having other thicknesses also can be used. The reflective metal layer 34 can be deposited onto the adhesion promoting layer 33 by vacuum deposition using known methods, or can be applied by any other suitable process. In one embodiment, the metal layer 34 is aluminum, though other reflective metals can also be used. The density of the metal layer 34 can be varied to achieve a desired degree of visible light transmission and emissivity. In one embodiment, the density of the metal layer 34 is selected to yield a film 30 having from about 17 to about 22 percent visible light transmission and an emissivity from about 0.27 to about 0.33. The adhesion-promoting coating 33 ensures strong adhesion of the metal layer 34 to the substrate 32.

In one embodiment, at least two coats 36a, 36b of a protective coating are applied over the metal layer 34. As shown in FIG. 6B, a first coat 36a of a highly transparent UV-curable polycarbonate coating is applied over the metal layer 34. In one embodiment, the first coat 36a is a liquid UV-curable polycarbonate coating which includes a mixture of about 75-85 percent pentaerythritol triacrylate, about 8-9 percent diluent, about 6-8 percent photo initiator, about 0.1-0.2 percent surface modifier, and about 3-5 percent trifunctional acid ester. The mixture can be combined with a suitable solvent at a ratio of about one part mixture to about four parts solvent. The liquid coating solution can be applied at a rate of about 4-5 pounds per ream of substrate, for example, and then continuously dried at an elevated temperature until only about 20 percent of the solution remains in the form of solids. The dried first coat 36a can then be exposed to ultraviolet light until the first coat 36a is partially cured. In one embodiment, the first coat 36a is sufficiently partially cured when it is dry to the touch and resists smearing, but can be scratched when scraped with a corner of a piece of cardboard, or the like. Once partially cured, the first coat 36a can have a thickness of about 1 micron to about 1.5 microns.

As shown in FIG. 6C, a second thin coat 36b of a highly transparent UV-curable polycarbonate coating is applied over the partially cured first coat 34. The second coat 36b can have the same composition as the first coat 36a described above. About 4-5 pounds of the liquid solution forming the second coat 36b can be applied per ream of substrate 32, for example. The applied second coat 36b can be continuously dried at an elevated temperature until only about 20 percent remains as solids. The dried coating material can then be exposed to ultraviolet light until both the first coat 36a and the underlying second coat 36b are fully cured. When fully cured, the first and second coats 36a, 36b can each be about 0.5 micron to about 1.5 microns thick, and can have a combined cured thickness of about 1 micron to about 3 microns, for example.

The inventors have discovered that the two-coat process described above yields a protective polycarbonate coating 36 which has a substantially uniform thickness, has exceptional transparency, strongly adheres to the metal layer 34, and is exceptionally hard and highly resistant to hazing, scratching, other mechanical damage, and damage due to chemical attack by cleaning solvents. For example, the maximum haze increase of the coating 36 when tested according to ASTM D 1044 can be less than about 3 percent. Accordingly, a low-emissivity film 30 having a protective polycarbonate coating 36 applied by such a method is believed to be substantially more durable than the protective coatings of other known non-laminated window films having low emissivities.

The above descriptions of various embodiments of the invention are intended to describe and illustrate various aspects and features of the invention without limiting the invention thereto. Persons of ordinary skill in the art will understand that various changes and modifications can be made to the described embodiments without departing from the scope of the invention. All such changes and modifications are intended to be within the scope of the appended claims.

What is claimed is:

1. A non-laminated low-emissivity window film comprising:
(a) a flexible polymeric substrate having a first surface and an opposed second surface;
(b) a metal-adhesion promoting layer disposed on the first surface;
(c) a reflective metal layer disposed on the metal adhesion-promoting layer; and
(d) a transparent polycarbonate coating disposed on the metal layer;
(e) wherein the window film has an emissivity of about 0.27 to about 0.33 and a visible light transmission of at least about 17 percent.

2. A non-laminated low-emissivity window film according to claim 1 wherein the polymeric substrate comprises polyester.

3. A non-laminated low-emissivity window film according to claim 1 wherein the polymeric substrate is substantially transparent to visible light, and has less than about 1 percent haze.

4. A non-laminated low-emissivity window film according to claim 1 wherein the polymeric substrate is colored.

5. A non-laminated low-emissivity window film according to claim 1 wherein the reflective metal layer comprises aluminum.

6. A non-laminated low-emissivity window film according to claim 1 wherein the transparent polycarbonate coating comprises pentaerythritol tetraacrylate, pentaerythritol triacrylate, an acrylic ester, a diluent, a photo initiator, a surface modifier, and a trifunctional acid ester.

7. A non-laminated low-emissivity window film according to claim 1 wherein the polycarbonate coating has a thickness that is less than or equal to about 3 microns.

8. A non-laminated low-emissivity window film according to claim 1 wherein the film has a thickness of about 0.5 mil to about 4.0 mils.

9. A non-laminated low-emissivity window film according to claim 1 wherein the polymeric substrate with the metal-adhesion promoting layer disposed on the first surface comprises Melinex® X6560 by DuPont Teijin Films™.

10. A non-laminated low-emissivity window film according to claim 1 further comprising an adhesive layer disposed on the second surface of the polymeric substrate.

11. A non-laminated low-emissivity window film according to claim 10 wherein the adhesive layer comprises a pressure sensitive adhesive, and further comprising a release liner disposed over the adhesive layer.

12. A non-laminated low-emissivity window film according to claim 10 wherein the adhesive layer comprises a colorant.

13. A method of producing a low-emissivity window film, the method comprising:
(a) providing a flexible polymeric substrate;
(b) depositing a metal layer on one surface of the polymeric substrate to form a metallized surface;
(c) applying a thin first coat of a UV-curable polycarbonate coating over the metallized surface;
(d) drying the first coat;
(e) exposing the first coat to ultraviolet light until the first coat is partially cured;
(f) applying a thin second coat of a UV-curable polycarbonate coating over the first coat;
(g) drying the second coat;
(h) exposing the first coat and the second coat to ultraviolet light until both the first coat and the second coat are fully cured.

14. A method according to claim 13 wherein the flexible polymeric substrate comprises polyester.

15. A method according to claim 13 wherein the polymeric substrate is substantially transparent to visible light, and has less than about 1 percent haze.

16. A method according to claim 13 wherein the polymeric substrate is colored.

17. A method according to claim 13 wherein the metal layer comprises aluminum.

18. A method according to claim 13 wherein both the first and second coats of the UV-curable polycarbonate coating comprise pentaerythritol tetraacrylate, pentaerythritol triacrylate, an acrylic ester, a diluent, a photo initiator, a surface modifier, and a trifunctional acid ester.

19. A method according to claim 13 wherein after the first coat and second coat are fully cured, the first and second coats have a combined thickness that is less than or equal to about 3 microns.

20. A method according to claim 13 wherein the polymeric substrate comprises a metal-adhesion promoting coating, and wherein the metal layer is deposited on the metal adhesion-promoting coating.

21. A method according to claim 20 wherein the polymeric substrate with the metal-adhesion promoting coating comprises Melinex® X6560 by DuPont Teijin Films™.

22. A low-emissivity window film produced according to the method of claim 13.
